(19) United States
(12) Patent Application Publication
(10) Pub. No.: US 2004/0252334 A1
(43) Pub. Date: Dec. 16, 2004

(54) Communication control device and method for image forming system

(75) Inventors: Kazuhito Tanimoto, Ebina-shi (JP); Junichi Furusawa, Ebina-shi (JP); Kazuhiro Ohya, Ebina-shi (JP); Nobuyuki Kobayashi, Ebina-shi (JP); Hideto Kizaki, Kawasaki-shi (JP); Hiroyuki Nunomiya, Ebina-shi (JP); Tetsuya Neriki, Ebina-shi (JP); Osamu Kobayashi, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/716,522

(22) Filed: Nov. 20, 2003

(30) Foreign Application Priority Data
Jun. 11, 2003 (JP) 2003-166599

(51) Int. Cl. G06F 15/00; H04N 1/00

(52) U.S. Cl. 358/1.15; 358/400

(57) ABSTRACT

An image forming system which performs communication among a plurality of devices comprises a communication control device, which is communicably connected to each of an image forming device, a computer, and a print control device, is arranged, and communication among these devices is performed through the communication control device. Therefore, commands transmitted from these devices are received by the communication control device. In the communication control device, when a command transmitted from any one of these devices is received, a transmission destination is automatically selected from the devices except a transmission source of the received command based on relation information, so that the command is transmitted to the device of the selected transmission destination.

### CROSS-REFERENCE TO RELATED APPLICATION

This application claims priority under 35USC 119 from Japanese Patent Application No. 2003-166599, the disclosure of which is incorporated by reference herein.

### BACKGROUND OF THE INVENTION

1. Field of the Invention

The present invention relates to an image forming system, a communication control device, and a method of controlling communication among plurality of devices included in an image forming devices included in the image forming system, and exemplary, relates to an image forming system which performs communication among a plurality of devices including at least an image forming device for forming an image based on image data, a control device, having a user interface, for controlling an operation of the image forming device based on an instruction input through the user interface, and an input device for inputting the image data, and a communication control device, and a method of controlling communication among plurality of devices included in an image forming devices included in the image forming system.

2. Description of the Related Art

Personal computers (hereinafter, referred to as PCs) have become widespread. A PC has many optional user interfaces, and can arbitrarily connect a desired user interface such as a display, a keyboard, a mouse, a touch panel display, or the like to use the connected user interface, and functions can be expanded by changing the software.

The PC is used as a device for controlling the image forming device (for example, a copying machine, a facsimile machine, a complex machine having at least two functions of such machines, and the like), so that a user inputs an instruction in the image forming device through the user interface on the PC side, resulting in operational improvement. Addition of a function and its concurrent screen design change can be easily achieved by upgrading an image forming device control program installed in the PC.

In this case, the image forming device may be used to configure an image forming system together with another device such as an input device (hereinafter referred to as a print control device) to input a job to have the image forming device perform a printing process. In the image forming system constituted by the plurality of devices as described above, when a PC is used as a device for controlling the operation of the image forming device, the PC and the devices other than the PC (the image forming device, the print control device, and the like) are generally connected to each other through a dedicated communication line. Therefore, the communication between the devices other than the PC (e.g., between the image forming device and the print control device) is performed through the PC. As a result, the PC is associated with all communications performed in the image forming system.

However, an OS (Operating System) generally installed in a PC is an OS called a non-real-time OS. According to characteristics of the OS, the OS cannot respond real time. In a conventional technique, for example, even information to be transmitted from the image forming device to the print control device temporarily passes through the PC. For this reason, a long period of time is required to transmit the information, posing a possible problem in real-time property of the image forming system.

### SUMMARY OF THE INVENTION

The present invention has been made to address the above problems.

In order to address the above problems the above object, according to a first aspect of the invention, there is provided an image forming system which includes at least an image forming device for forming an image based on image data, and a control device, having a user interface, for controlling an operation of the image forming device based on an instruction input through the user interface, and an input device for inputting the image data, including a communication controller which is designed to perform communication with each of a plurality of devices. When the communication controller receives a command transmitted from any one of the plurality of devices, based on the received command, selects at least one device as a transmission destination from the plurality of devices except a transmission source of the received command, and transmits the received command to the selected device.

According to the first aspect of the invention, in the image forming system, communication is performed among the plurality of devices including at least the image forming device, the control device, and the input device. By arranging the communication control so that it is connected to each of the plurality of devices, the communication controller can communicate with each of the devices. Thus, a command transmitted from any one of the plurality of devices can be received by the communication controller. When a command is transmitted from any one of the plurality of devices and is received by the communication controller, the communication controller automatically selects a transmission destination from the devices other than the device serving as the transmission source of the received command. The command is then transmitted to the selected device serving as the transmission destination.

The command transmitted from the image forming device is classified as any one of a command to be transmitted to both the control device and the input device, a command to be transmitted to the control device, and a command to be transmitted to the input device, in accordance with the command type. When a command is transmitted from the control device, the command is classified by the communication controller as any one of commands to be transmitted to both the image forming device and the input device, a command to be transmitted to the image forming device, and a command to be transmitted to the input device, in accordance with the command type. When a command is transmitted from the input device, in accordance with the command type, the command is classified by the communication controller as any one of commands to be transmitted to both the image forming device and the control device, a command to be transmitted to the image forming device, and a command to be transmitted to the control device.

In this manner, the communication controller is interposed, and a transmission destination of a command is classified by the communication controller, so that communication among the plurality of devices is performed. For this reason, communication between the image forming device and the input device, for example, can be performed without passing through the control device.

For example, the communication controller may select the control device and the input device as transmission destinations when the received command is a command from the image forming device which requests the image data to be transferred in response to the time the image is formed.

The communication controller may select the image forming device as a transmission destination when the received command is a command from the control device which requests a diagnosis of the state of the image forming device, and may select the control device as a transmission destination when the received command is a command from the image forming device which provides notification of the state of the image forming device as a result of the diagnosis.

The communication controller may select the image forming device and the input device as transmission destinations when the received command is a command from the control device which instructs controlling the power supply or provides notification of an abnormality in the control device.

The communication controller may select a device which performs at least some of processes for performing image control to adjust an image formed by the image forming device as a transmission destination when the received command is a command from the image forming device which provides information on the formed image.

The communication controller may select any one of the control device and the input device as a transmission destination when the received command is a command from the image forming device which provides notification that the image data and the formed image match with each other, and may select both the control device and the input device as transmission destinations when the received command is a command from the image forming device which provides notification that the image data and the formed image do not match with each other.

In this manner, in order to select a transmission destination in accordance with the command type, the communication controller may include a memory which stores relation information between the type of the command and a device serving as a transmission destination, and may select a device relating to the received command.

The communication controller may be arranged in the image forming device.

According to a second aspect of the invention, there is provided a communication control device included in the image forming system, the communication control device comprising: a plurality of communication controllers corresponding to each of a plurality of devices included in the image forming system; and a controller, which performs control so that when a command is transmitted from any one of the plurality of devices through the communication controller corresponding to the selected devices, at least one device is selected as a transmission destination from the plurality of devices except a transmission source of the received command, and control is performed such that the received command is transmitted to the selected device through the communication controller corresponding to the selected device, wherein the plurality of devices includes at least an image forming device that forms an image based on image data, a control device that controls an operation of the image forming device based on an instruction input through a user interface, and an input device that inputs the image data.

According to a third aspect of the invention, there is provided a method of controlling communication among a plurality of devices included in an image forming system, the method being performed by a communication control device included in the image forming system, the method comprising the steps of: (a) receiving a command transmitted from any one of the plurality of devices; (b) selecting at least one device from the plurality of devices except a transmission source of the received command as a transmission destination based on the received command; and (c) transmitting the received command to the selected device; wherein the plurality of devices include at least an image forming device that forms an image based on image data, a control device that controls an operation of the image forming device based on an instruction input through a user interface, and an input device that inputs the image data.

As described above, according to the invention, in an image forming system for performing communication among a plurality of devices, communication efficiency can be improved, and stable operation can be achieved.

### BRIEF DESCRIPTION OF THE DRAWINGS

FIG. 1 is a block diagram showing a communication connection of an image forming system according to an embodiment of the present invention.

FIG. 2 is a block diagram showing a schematic configuration of the image forming system according to the embodiment of the present invention.

FIG. 3 is a block diagram showing a detailed configuration of a communication control device according to the embodiment of the present invention.

FIG. 4 is a diagram showing an example of relation information.

FIG. 5 is a flow chart showing a communication control process executed in the communication control device according to the embodiment of the present invention.

FIGS. 6A and 6B are communication control diagrams showing a first communication control performed among an image forming device, a computer, and a print control device through the communication control device.

FIG. 7 is a communication control diagram showing a second communication control performed among the image forming device, the computer, and the print control device through the communication control device.

FIG. 8 is a communication control diagram showing a third communication control performed among the image forming device, the computer, and the print control device through the communication control device.

FIG. 9 is a communication control diagram showing a fourth communication control performed among the image forming device, the computer, and the print control device through the communication control device.

FIGS. 10A and 10B are communication control diagrams showing a fifth communication control (when image control is performed by the print control device) performed among the image forming device, the computer, and the print control device through the communication control device.

FIGS. 11A and 11B are communication control diagrams showing the fifth communication control (when image control is performed by the computer) performed among the image forming device, the computer, and the print control device through the communication control device.

FIGS. 12A and 12B are communication control diagrams showing a sixth communication control (matched state) performed among the image forming device, the computer, and the print control device through the communication control device.

FIGS. 13A and 13B are communication control diagrams showing the sixth communication control (mismatched state) performed among the image forming device, the computer, and the print control device through the communication control device.

### DETAILED DESCRIPTION OF THE INVENTION

An embodiment of the present invention will be described below in detail with reference to the accompanying drawings.

[Configuration of Image Forming System]

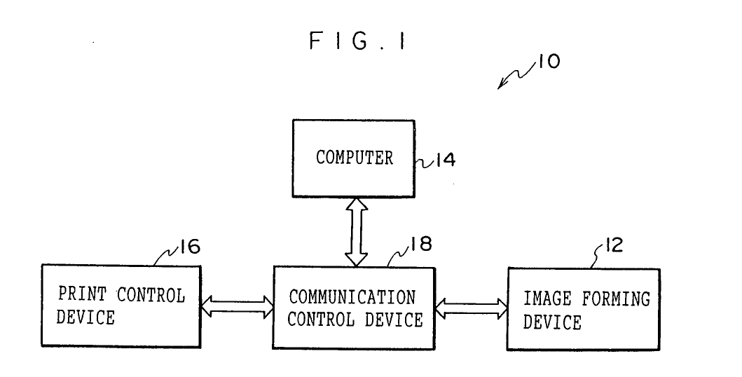

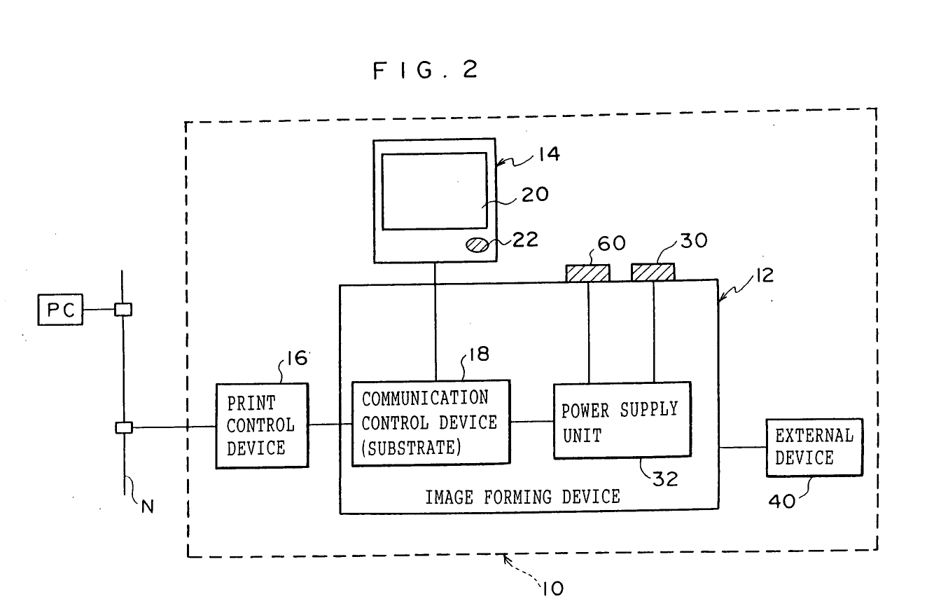

FIGS. 1 and 2 show an image forming system according to an embodiment of the present invention. As shown in FIGS. 1 and 2, an image forming system 10 comprises an image forming device 12 that prints an image based on image data on an image recording medium such as a sheet of paper to output the image, a computer 14 serving as a control device that controls the image forming device 12, a print control device 16 serving as an input device that inputs image data to be printed to the image forming device 12, and a communication control device 18 serving as a communication controller that controls communication among these devices. The image forming device 12, the computer 14, and the print control device 16 are connected to the communication control device 18 such that the image forming device 12, the computer 14, and the print control device 16 can communicate with the communication control device 18. In the image forming system 10, the computer 14, the print control device 16, and the image forming device 12 communicates with each other through the communication control device 18.

The image forming device 12, the computer 14, and the print control device 16 are each connected to the communication control device 18 by suitably using a cable which conforms to a predetermined standard such as USB or IEEE1394 and an interface conforming to the standard.

A general personal computer comprising a CPU, a RAM, a ROM, a power supply unit, and the like can be used as the computer 14. The computer 14 comprises a user interface 20 and a power supply switch 22 to turn on and off the power supply of the computer 14. A combination of an operation unit such as a mouse or a keyboard, and a display unit such as a display is generally used as the user interface 20. FIG. 2 shows an example of using a touch panel display obtained by overlaying a touch panel on a display panel consisting of a liquid crystal display plate.

A program for controlling the image forming device 12 is pre-installed in the computer 14. The computer 14 is controlled such that the image forming device 12 is operated by execution of the program based on various instructions input by a user through the user interface 20.

The print control device 16 is connected to a network N. A print job which instructs the image forming system to perform a printing process is input from another device (PC in FIG. 2) connected to the network N to the print control device 16 through the network N.

The print job includes data (hereinafter referred to as page data) indicating each of the pages to be printed. In general, each page is composed of characters, images, and graphics. The page data is PDL (Page Description Language) data obtained such that an image obtained by arranging the constituent elements on a page is described by PDL.

The print control device 16 temporarily registers input print jobs in a print queue. The registered print jobs are sequentially picked from the print queue in the order of registration. Page data included in the picked print job, i.e., data obtained by describing each page to be printed by PDL, is analyzed, and image data obtained by expressing the image of the page by a set of dots is generated. The print control device 16 functions as a so-called RIP (Raster Image Processor) which develops the page data into image data of a raster format which can be processed by the image forming device 12. The print control device 16 outputs the generated image data to the image forming device 12 after an output process on the image forming device 12 is ready.

As the input device, in addition to the print control device 16, for example, a scanner device for reading an image from an original, a facsimile device for receiving image data through a public line, a mail server for receiving an electronic mail, or the like can be used. In such a device, the image data is converted into image data of a format which can be subjected to a print process by the image forming device 12 (image data is generated), and the image data is output to the image forming device 12.

The image forming device 12 comprises a printer engine serving as a mechanism unit for actually executing a print process and a printer controller serving as a control system for the printer engine. By means of the control of the printer controller, in the printer engine, an image is printed on an image recording medium such as, for example, a sheet of paper by using an image forming material such as toner or ink based on the input image data, and the image recording medium is output. In the embodiment of the present invention, as an example, toner is used as the image recording medium. In the printer engine, based on the input image data, an exposure head is turned on and off to expose a photosensitive material uniformly charged on the image recording medium, thereby forming a latent image. A toner image obtained by developing the latent image by toner is transferred to a sheet of paper, so that images are printed on sheets of paper on a page-by-page basis.

An external device 40 such as a scanner device for verifying an output image can be suitably and communicably connected to the image forming device 12 as needed (see FIG. 2).

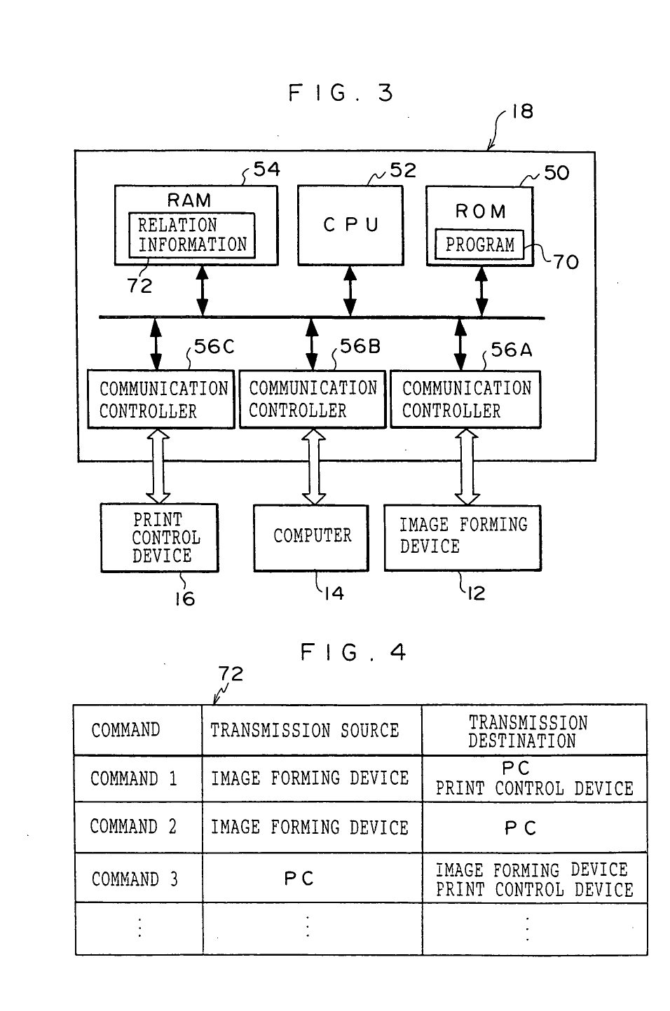

The communication control device 18 comprises, as shown in FIG. 3, a ROM 50 in which a program 70 for controlling the operation of the communication control device 18 and data are stored in advance, a CPU 52 serving as a controller that executes the program of the ROM 50, a RAM 54 in which relation information 72 is stored in advance and which is used as a work memory in execution of the program, and communication controllers 56A, 56B and 56C for transmitting and receiving various commands and data to/from the image forming device 12, the computer 14, and the print control device 16. The CPU 52, the RAM 54, the ROM 50, and the communication controllers 56A, 56B, and 56C are connected to each other via a bus BUS. The program 70 and the relation information 72 may be stored in either one of the ROM 50 and the RAM 54.

The relation information 72 shows relationships among commands, transmission sources, and the devices of transmission destinations in accordance with the command types. The devices of the transmission destinations are devices other than the transmission sources.

In the communication control device 18, the program 70 is executed by the CPU 52 to transmit a command received by any one of the communication controllers 56A, 56B, and 56C from any one of the communication controllers 56A, 56B, and 56C other than the communication controller which has received the command.

In the image forming system 10, when a command is transmitted from any one of the image forming device 12, the computer 14, and the print control device 16, the command is transmitted to the communication control device 18 and is received by any one of the communication controllers 56A, 56B, and 56C corresponding to the device of the transmission source. In the communication control device 18, a transmission destination of the received command is selected based on the relation information 72, and the received command is transmitted from any one of the communication controllers 56A, 56B, and 56C corresponding to the device of the selected transmission destination. In this manner, in the image forming system 10, the communication control device 18 classifies commands transmitted from the image forming device 12, the computer 14, and the print control device 16, so that the commands can be transmitted to the devices of proper transmission destinations, respectively.

In the communication control device 18, in the above communication control, data indicating the status of communication performed among the print control device 16, the image forming device 12, and the computer 14 is generated by the CPU 52, and the generated data is accumulated and stored in the RAM 54 as communication history. Since the communication history is accumulated and stored, when an abnormality occurs, the time of the abnormality occurrence and past communication status can be verified.

The communication control device 18 is set in a communication controllable state when at least one of the image forming device 12 and the computer 14 is ON.

The communication control device 18 may be a physically independent device, or may be mounted on another device such as, for example, the image forming device 12, the computer 14, or the print control device 16. In the present embodiment, as an example, as shown in FIG. 2, a substrate on which the communication control device 18 is packaged is mounted on the image forming device 12, and power for driving the communication control device 18 is supplied from a power supply unit 32 of the image forming device 12.

The power supply unit 32 of the image forming device 12 supplies power to the essential function unit (function excluding the communication control device 18, i.e., a printer engine, a printer controller, or the like) of the image forming device 12. The image forming device 12 also supplies power to the communication control device 18. For this reason, the image forming device 12 comprises a sub-power supply switch 30 and a main power supply switch 60. When the sub-power supply switch 30 is turned off, only the power supply of the image forming device 12 is turned off, while power supply to the communication control device 18 is continued. When the main power supply switch 60 is turned off, the power supply of the image forming device 12 and power supply to the communication control device 18 are turned off (stopped). In this manner, when the communication control device 18 is mounted on the image forming device 12, space required for installing the communication control device 18 when the communication control device 18 is independently arranged can be omitted, and general-purpose devices provided by a vender can be used as the computer 14 and the print control device 16, respectively.

[Operation]

Communication control performed by the communication control device 18 will be described below as an operation of the present embodiment.

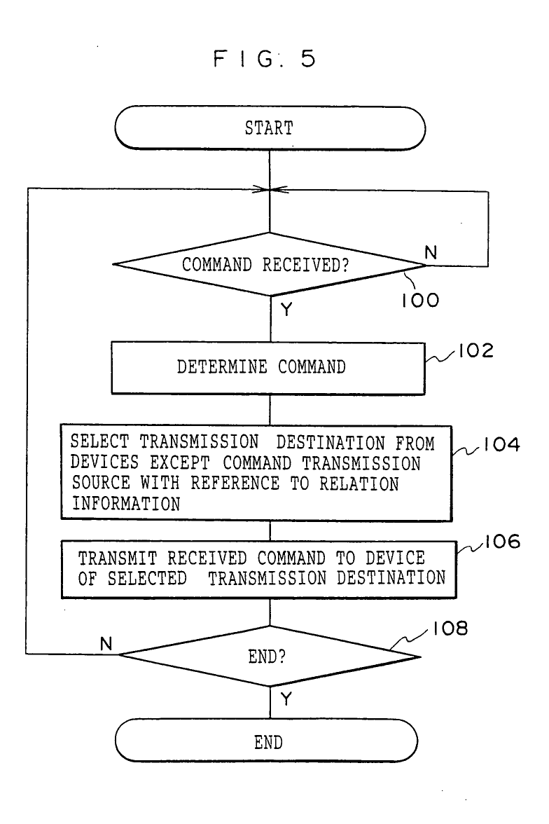

FIG. 5 shows a communication control process performed by the communication control device 18. This communication control process is performed such that the program 70 is executed by the CPU 52.

As shown in FIG. 5, in step 100, the communication control device 18 waits until any one of the communication controllers 56A, 56B, and 56C receives a command. When a command is transmitted from any one of the image forming device 12, the computer 14, and the print control device 16, the command is received by any one of the communication controllers 56A, 56B, and 56C corresponding to the corresponding device. Thereafter, the procedure proceeds to step 102.

In step 102, the received command is determined. In a next step 104, a transmission destination corresponding to the command is selected with reference to the relation information 72. At this time, as described above, the relation information 72 is set such that the device of the transmission destination is a device other than the device of the transmission source. For this reason, the transmission destination is selected from the devices other than the device of the transmission source.

In a next step 106, the received command is transmitted from any one of the communication controllers 56A, 56B, and 56C corresponding to the device of the selected transmission destination. In this manner, the received command can be transmitted to the device of the selected transmission destination.

Thereafter, until the operation of the communication control device 18 is terminated, the CPU 52 returns from a next step 108 to step 100. When the operation of the communication control device 18 is terminated, the determination in step 108 is affirmative, and the communication control process in FIG. 5 is terminated.

In the image forming system 10, by the communication control process performed by the communication control device 18, when the respective commands and the transmission destinations are associated with each other in advance by the relation information 72, the communication control device 18 classifies the transmission destinations of various commands transmitted from the image forming device 12, the computer 14, and the print control device 16. As a result, various communication processes among these devices can be controlled.

A command transmitted from the image forming device 12 is classified as any one of a command to be transmitted to both the computer 14 and the print control device 16, a command to be transmitted to the computer 14, and a command to be transmitted to the print control device 16, in accordance with the command type. A command transmitted from the computer 14 is classified as any one of a command to be transmitted to both the image forming device 12 and the print control device 16, a command to be transmitted to the image forming device 12, and a command to be transmitted to the print control device 16, in accordance with the command type. A command transmitted from the print control device 16 is classified as a command to be transmitted to both the image forming device 12 and the computer 14, a command to be transmitted to the image forming device 12, and a command to be transmitted to the computer 14, in accordance with the command type.

Examples of the first to sixth communication control will be described below.

(First Communication Control Example)

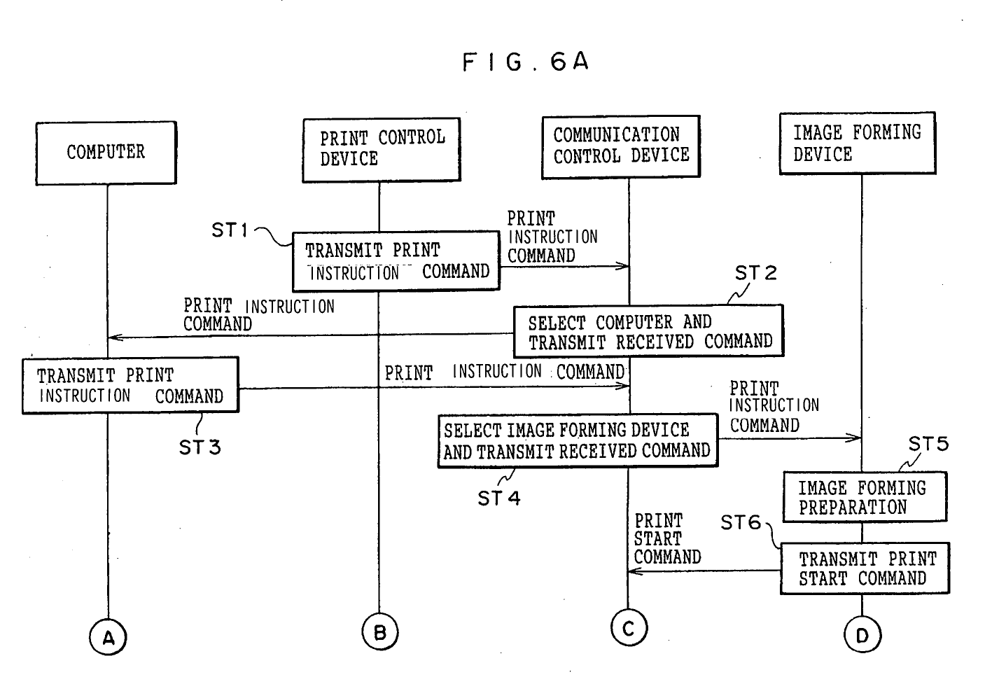

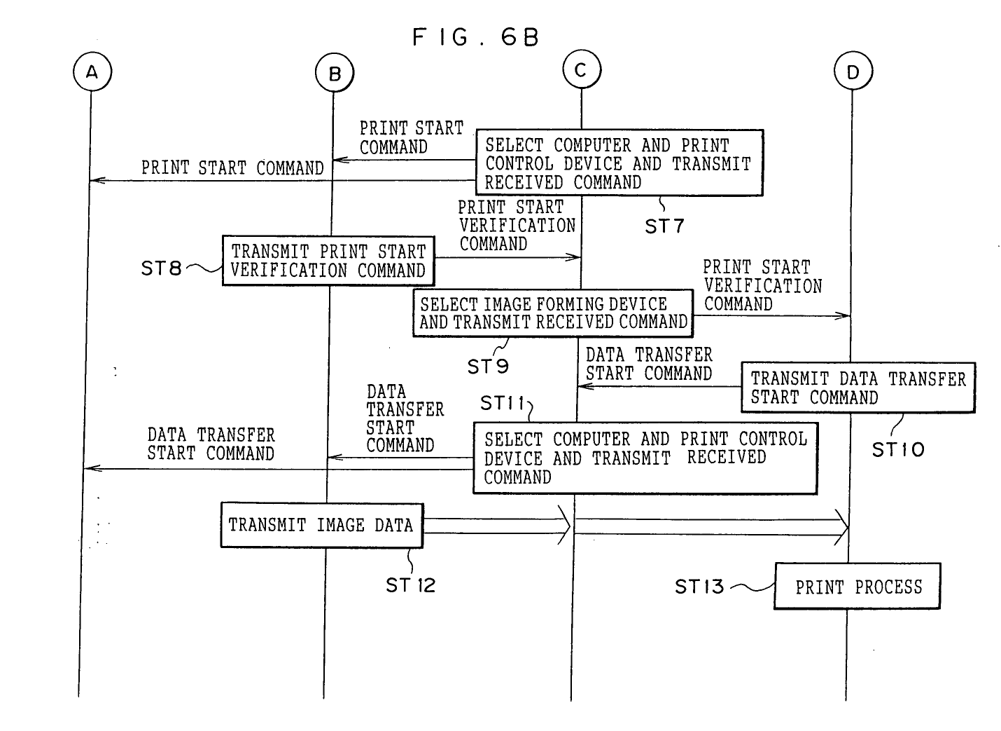

An example of communication control performed when a print job is input to the print control device 16 will be described below with reference to FIGS. 6A and 6B.

As shown in FIGS. 6A and 6B, when a print job is input to the print control device 16, a print instruction command is output from the print control device 16 (step ST1). The print instruction command transmitted from the print control device 16 is received by the communication control device 18. When the communication control device 18 receives the print instruction command, the communication control device 18 selects the computer 14 as a transmission destination to transmit the print instruction command to the computer 14 (step ST2).

When the computer 14 receives the print instruction command, the computer 14 adds appropriate parameter data or the like to the print instruction command as needed to send back the print instruction command (step ST3). When the communication control device 18 receives the print instruction command transmitted from the computer 14, the communication control device 18 selects the image forming device 12 as a transmission destination to transmit the print instruction command to the image forming device 12 (step ST4).

Therefore, with communication through the communication control device 18, the print instruction command is transmitted to the computer 14 and the image forming device 12. A case in which the command is transmitted to the two devices will be described as a one-step process.

The image forming device 12 performs a process for image output preparation such as activation of the printer engine in response to the print instruction command (step ST5). When the image output preparation is completed, the image forming device 12 transmits a print start command (step ST6). The print start command is received by the communication control device 18. When the communication control device 18 receives the print start command, the communication control device 18 selects the computer 14 and the print control device 16 as transmission instructions to transmit the print start command to the computer 14 and the print control device 16 (step ST7).

The print control device 16 receives the print start command, and the print control device 16 transmits a print start verification command indicating whether output ready for image data is completed or not (OK/NG) (step ST8). The print start verification command is received by the communication control device 18. When the communication control device 18 receives the print start verification command, the communication control device 18 selects the image forming device 12 as a transmission destination to transmit the print start verification command to the image forming device 12 (step ST9).

The image forming device 12 receives the print start verification command. When the print start verification command indicates that the output preparation for image data is completed (OK), a data transfer start command which is a command for requesting transfer of image data is transmitted in synchronization with a print output (step ST10). The data transfer start command corresponds to a command from an image forming device for requesting the transfer of image data in response to the time the image is formed in the present invention.

When the print start verification command indicates that the preparation for image data is not completed (NG), the image forming device 12 sends back the print start command until the image forming device 12 receives the print start verification command indicating that the output preparation for image data is completed.

The data transfer start command transmitted from the image forming device 12 is received by the communication control device 18. When the communication control device 18 receives a data transfer start command, the communication control device 18 selects the computer 14 and the print control device 16 as transmission destinations to transmit the data transfer start command to the computer 14 and the print control device 16 (step ST11). The print control device 16 receives the data transfer start command to start transmission of image data to the image forming device 12 (step ST12). The image data is transmitted to the image forming device 12 through the communication control device 18. The image forming device 12 prints an image based on the image data (step ST13). The computer 14, having received the data transfer start command, can recognize a print output timing of the image forming device 12, and based on the timing, the computer 14 can suitably control the operation of the image forming device 12.

(Second Communication Control Example)

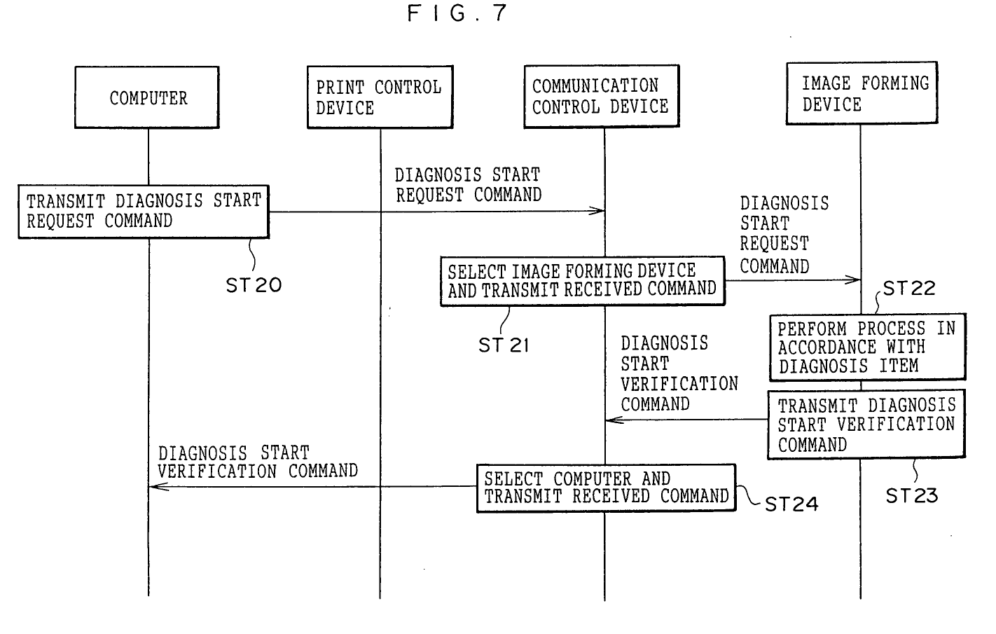

An example of communication control performed when the state of the image forming device 12 is diagnosed in the computer 14 will be described below with reference to FIG. 7. Diagnosis items include initialization of an NVM (nonvolatile memory) held by the image forming device 12 to store various data such as, for example, an image quality parameter or an operation history, readout of predetermined data from the NVM, writing of data in the NVM, operation check of members or the like in the printer engine, and the like.

As shown in FIG. 7, the computer 14 transmits a diagnosis start request command at a predetermined timing which is determined in advance (for example, immediately after the start of the computer 14, immediately after the start of the image forming device 12, each time a predetermined time has elapsed, each time a predetermined number of sheets of paper are output, or the like) (step ST20). A parameter indicating diagnosis item to be diagnosed is added to the diagnosis start request command. More specifically, the diagnosis start request command corresponds to a command from the control device, which requests a diagnosis of the state of the image forming device of the invention.

The diagnosis start request command is received by the communication control device 18. When the communication control device 18 receives the diagnosis start request command, the communication control device 18 selects the image forming device 12 as a transmission destination to transmit the diagnosis start request command to the image forming device 12 (step ST21).

The image forming device 12 receives the diagnosis start request command to perform a process in accordance with a diagnosis item expressed by the added parameter (step ST22), and transmits a diagnosis start verification command indicating a process result (step ST23). The diagnosis start verification command corresponds to a command from the image forming device, which provides notification of the state of the image forming device as a result of the diagnosis.

The diagnosis start verification command is received by the communication control device 18. When the communication control device 18 receives the diagnosis start verification command, the communication control device 18 selects the computer 14 as a transmission destination to transmit the diagnosis start verification command to the computer 14 (step ST24). The computer 14 diagnoses the state of the image forming device 12 by the diagnosis start verification command.

(Third Communication Control Example)

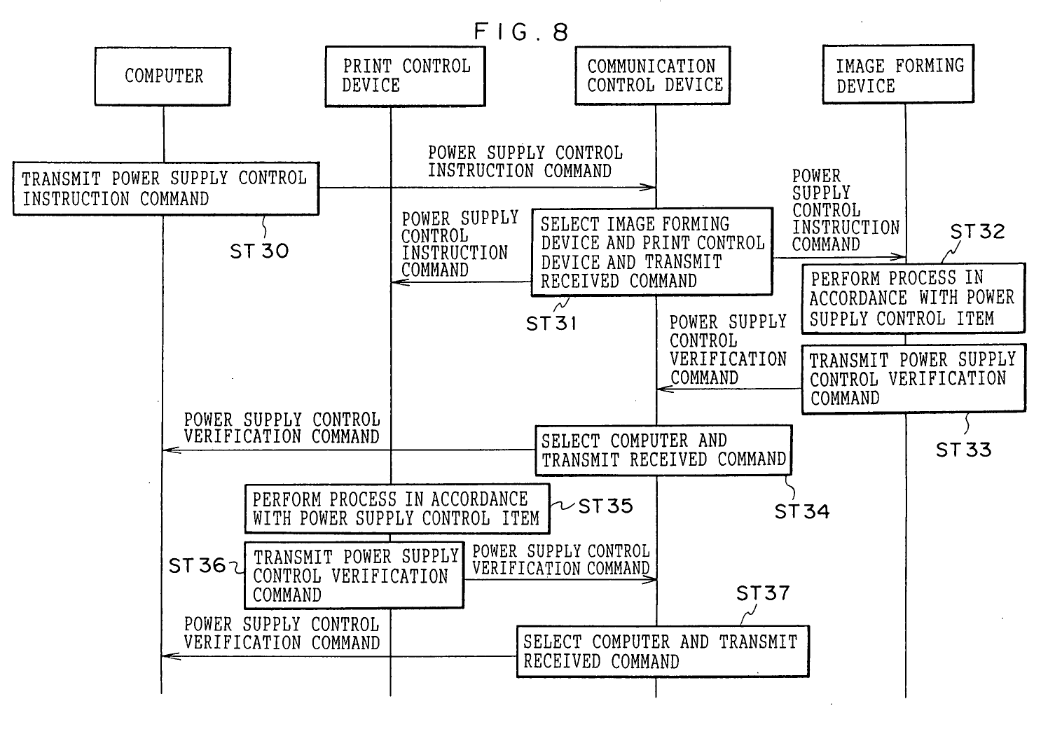

An example of communication control performed when power supply control for the image forming device 12 and the print control device 16 is performed in the computer 14 will be described below with reference to FIG. 8. Power supply control items include transition of the power supply states of the devices to ON states, transition to OFF states, transition to SLEEP states (power saving states), notification of the power supply state of the computer 14, and the like.

As shown in FIG. 8, when a power supply control instruction for turning off the power supply is input by a user, or when a predetermined timing which is determined in advance has elapsed (for example, immediately after the start of the computer 14, when a predetermined time has elapsed after the user's last operation of the computer 14, or the like), the computer 14 transmits a power supply control instruction command (step ST30). A parameter indicating a power supply control item desired by the user is added to the power supply control instruction command. The power supply control instruction command corresponds to a command from a control device, which instructs power supply control of the invention.

The power supply control instruction command is received by the communication control device 18. When the communication control device 18 receives the power supply control instruction command, the communication control device 18 selects the image forming device 12 and the print control device 16 as transmission instructions to transmit the power supply control instruction command to the image forming device 12 and the print control device 16 (step ST31).

The image forming device 12 receives the power supply control instruction command to perform a process in accordance with a power supply control item indicated by an added parameter (step ST32). Upon completion of the process, the image forming device 12 transmits a power supply control verification command (step ST33). This power supply control verification command is received by the communication control device 18. When the communication control device 18 receives the power supply control verification command, the communication control device 18 selects the computer 14 as a transmission destination to transmit the power supply control verification command to the computer 14 (step ST34).

Similarly, the print control device 16 also receives the power supply control instruction command to perform a process in accordance with a power supply control item indicated by an added parameter (step ST35). Upon completion of the process, the power supply control verification command is transmitted (step ST36). The power supply control verification command is also received by the communication control device 18. The communication control device 18, as described above, selects the computer 14 as a transmission destination to transmit the power supply control verification command to the computer 14 (step ST37).

In response to the power supply control verification commands from the image forming device 12 and the print control device 16, the computer 14 can verify that requested power supply controls of the image forming device 12 and the print control device 16 are performed.

In this manner, the power supply control instruction command transmitted from the computer 14 is transmitted to the image forming device 12 and the print control device 16, so that the power supply controls of both the devices can be performed at once.

(Fourth Communication Control Example)

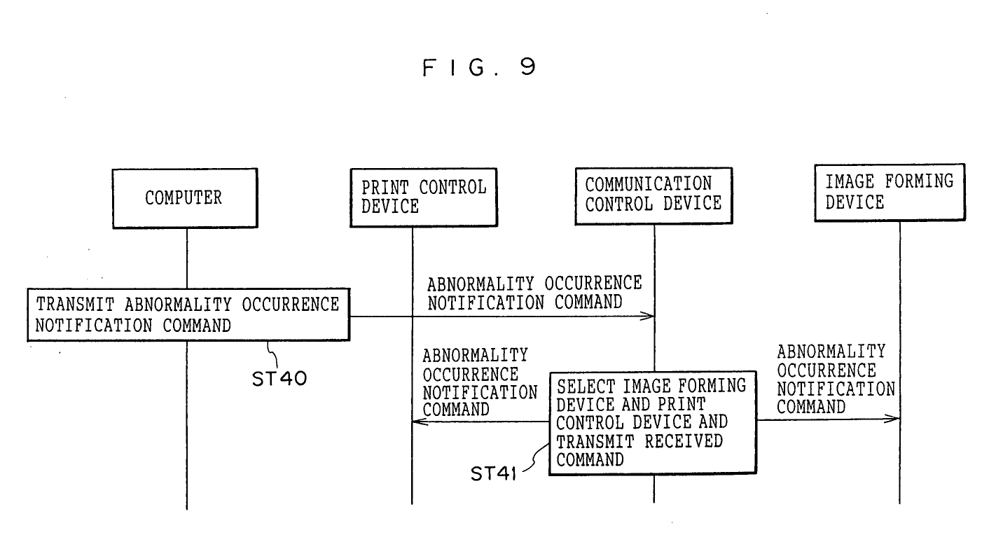

An example of communication control effected when a certain abnormality, which affects the operation of the image forming system 10, occurs in the computer 14 will be described below with reference to FIG. 9. Examples of such cases of abnormality include, for example, a disk abnormality of a HDD or the like.

As shown in FIG. 9, when an abnormality which affects the operation of the image forming system 10 occurs, the computer 14 transmits an abnormality occurrence notification command which provides notification of the abnormality occurrence (step ST40). The abnormality occurrence notification command corresponds to a command from a control device, which provides notification of an abnormality in the control device of the invention.

The abnormality occurrence notification command is received by the communication control device 18. When the communication control device 18 receives the abnormality occurrence notification command, the communication control device 18 selects the image forming device 12 and the print control device 16 as transmission destinations to transmit the abnormality occurrence notification command to the image forming device 12 and the print control device 16 (step ST41) In this manner, the abnormality occurrence notification command transmitted from the computer 14 is transmitted to the image forming device 12 and the print control device 16, so that the abnormality in the computer 14 can be immediately notified to the image forming device 12 and the print control device 16. A troubleshooting process corresponding to the abnormality notification can be suitably executed by the image forming device 12 and the print control device 16.

(Fifth Communication Control Example)

An example of a communication control performed when image control is performed for the image forming device 12 will be described below. Image control is performed to adjust the image quality of an output image from the image forming device 12, or to adjust a print position of an image on a sheet of paper.

For the image control, as the external device 40, a scanner in which output sheets of paper on which images are printed by the image forming device 12 are filled and which can obtain the density and colorimetry values of the images (hereinafter, referred to as output images) printed on the sheets of paper is connected to the image forming device 12 in advance. In place of connecting the scanner as the external device 40, a sensor for measuring the density and color of an output image or an image (for example, a toner image formed on a photoreceptor drum or on an intermediate transfer belt) corresponding to the output image may be arranged in the image forming device 12.

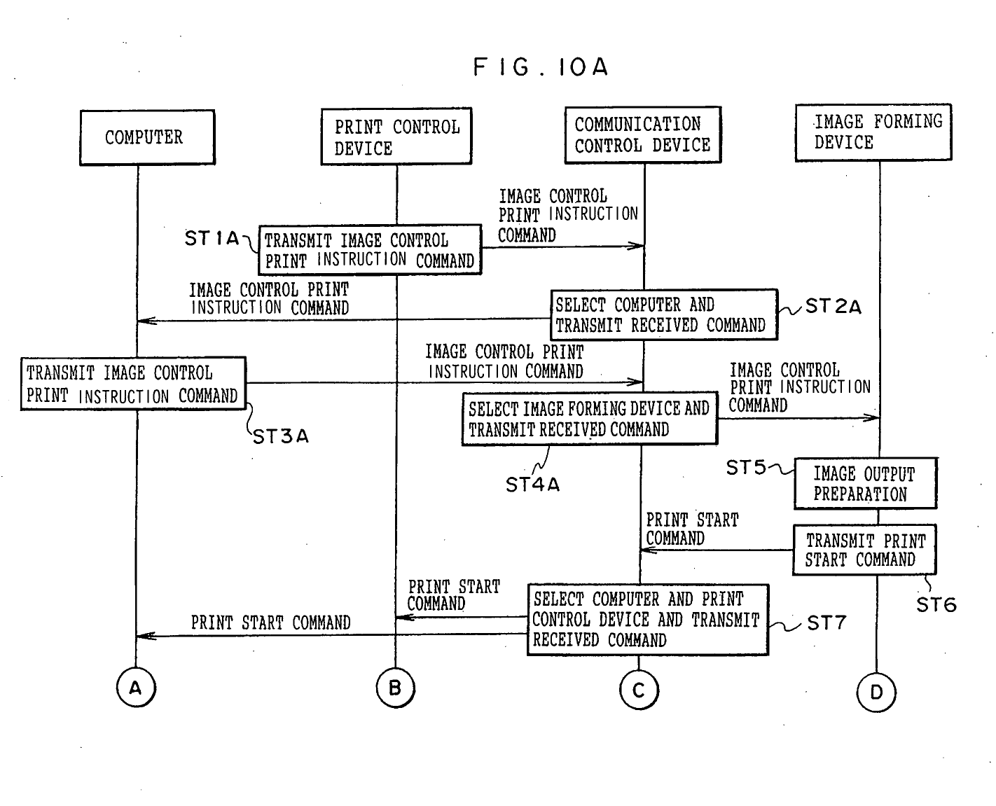

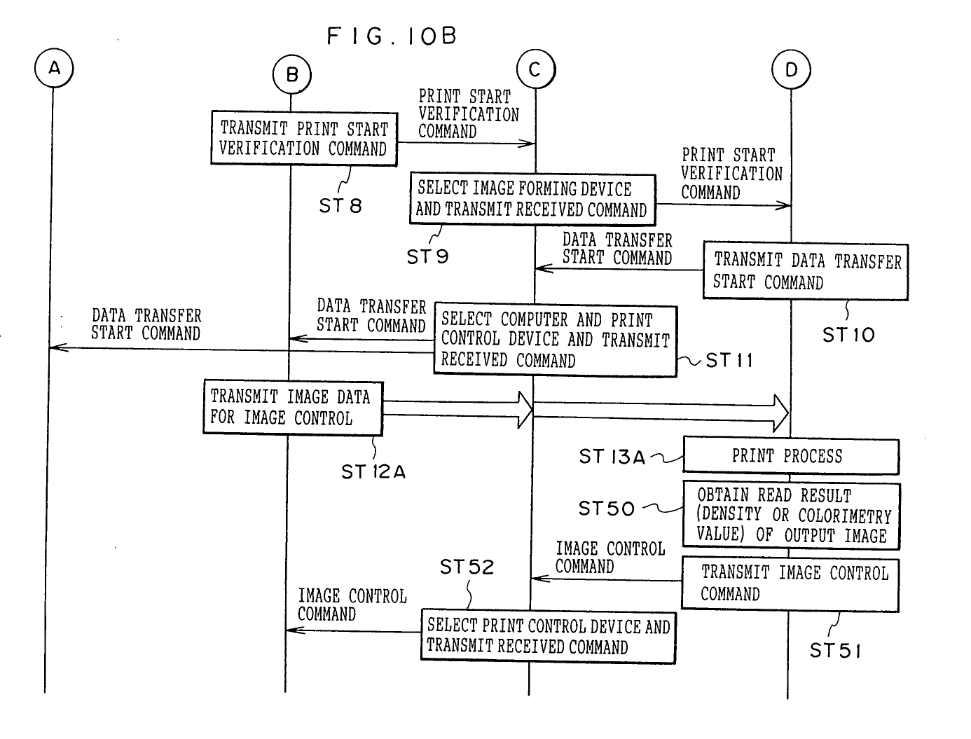

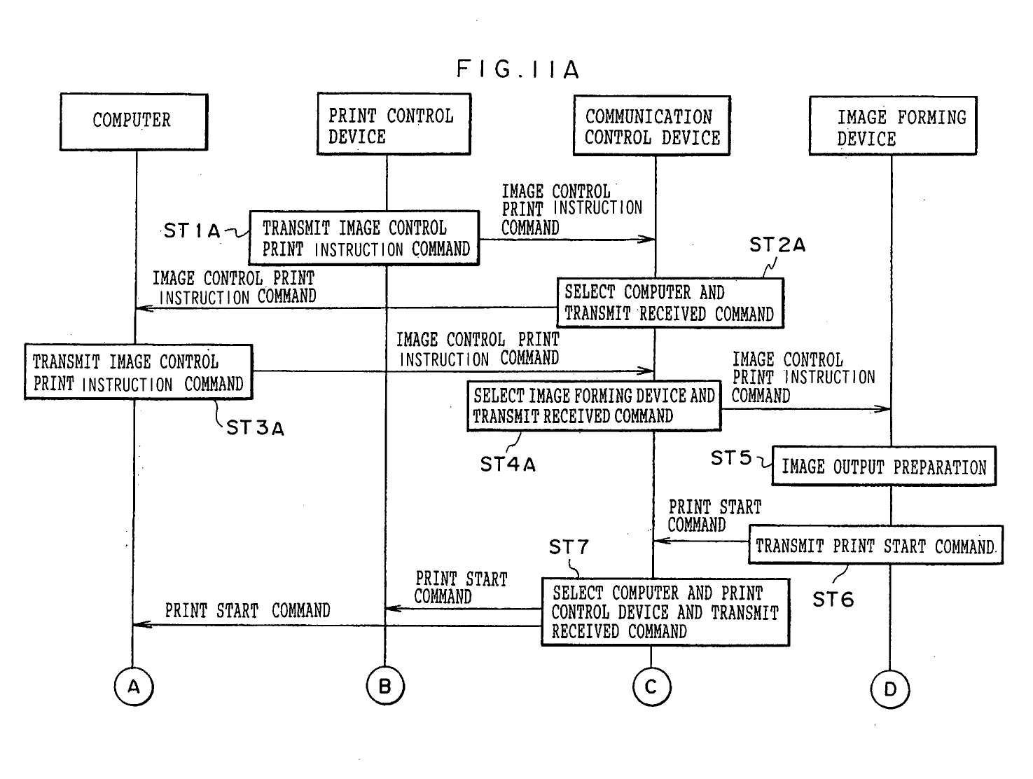

A case in which a process for performing image control for the image forming device 12 is performed in the print control device 16 will be described below with reference to FIGS. 10A and 10B. The processes in FIGS. 10A and 10B that are the same as in FIGS. 6A and 6B are indicated by the same step numbers, and a detailed description thereof will be omitted.

As shown in FIGS. 10A and 10B, in the image forming system 10, at a predetermined timing (for example, when the first image is output after the start of the image forming system 10, each time a predetermined number of sheets of paper are output, or the like) which is determined in advance, an image control print instruction command is transmitted from the print control device 16 (step ST1A). This image control print instruction command, as in the first communication control example, is transmitted to the computer 14 by the communication control device 18 (step ST2A). When the image control print instruction command is sent back from the computer 14 (step ST3A), the image control print instruction command is transmitted to the image forming device 12 (step ST4A).

Subsequently, an image output preparation process is performed by the image forming device 12, and after a print start command, a print start verification command, and a data transfer start command are transmitted and received by the image forming device 12, the computer 14, and the print control device 16 through the communication control device 18, transmission of image data for image control is started in the print control device 16 (step ST12A). The image data for image control is transmitted to the image forming device 12 through the communication control device 18. As the image data for image control, predetermined image data stored in advance in the print control device 16 to print a so-called color patch may be used, or image data generated from data input as a print job may be used.

When the image forming device 12 receives the image data for image control, the image forming device 12 performs a print process based on the image data for image control (step 13A). An output image (color patch) obtained as a result is read by the scanner which is the external device 40, and data indicating a read result (output image density or colorimetry value) is obtained (step ST50). The image forming device 12 transmits data indicating the obtained read result as an image control command (step ST51). The image control command corresponds to a command for providing information relating to the formed image.

The image control command is received by the communication control device 18. When the communication control device 18 receives the image control command, the communication control device 18 selects the print control device 16 as a transmission destination to transmit the image control command to the print control device 16 (step ST52). In this manner, the read result of the output image is notified to the print control device 16.

The print control device 16, as a process for performing image control for the image forming device 12, generates data (for example, a parameter or the like for color control) for image control based on the read result of the notified output image, and feeds the generated data back to the image forming device 12 or the print control device 16 at an arbitrary timing. With this feedback, image quality or the like is properly controlled when an image is output from the image forming device 12 and subsequent devices.

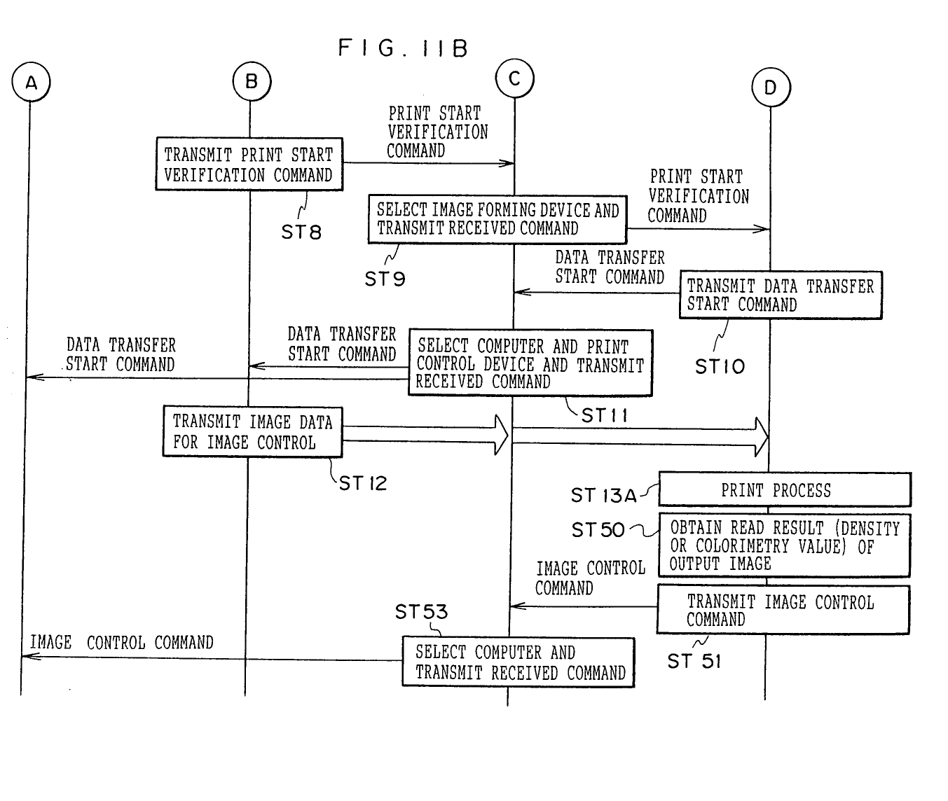

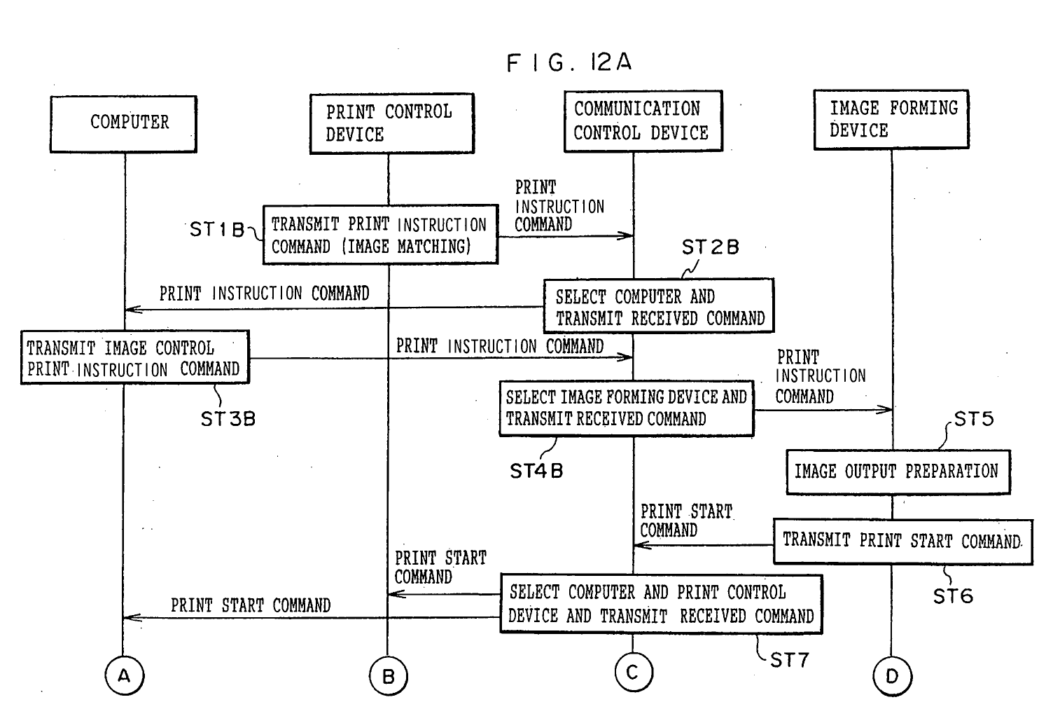

In FIGS. 10A and 10B, in the print control device 16, the case in which image control for the image forming device 12 is performed is indicated. However, this process can also be performed in the computer 14. In a case in which the process for performing image control for the image forming device 12 is performed in the computer 14, as shown in FIGS. 11A and 11B, when the image control command transmitted from the image forming device 12 (step ST51) is received by the communication control device 18, the communication control device 18 selects the computer 14 as a transmission destination and may transmit the image control command to the computer 14 (step ST53). The processes in FIGS. 11A and 11B that are the same as in FIGS. 10A and 10B are indicated by the same step numbers.

In this manner, when the image control command is transmitted to the computer 14, a read result of an output image can be notified to the computer 14. The computer 14, as a process for performing image control for the image forming device 12, generates data (for example, a parameter for color control or the like) for image control based on the read result of the notification of output image, and feeds the generated data back to the image forming device 12 or the print control device 16 at an arbitrary timing.

A process for performing image control for the image forming device 12 may be separately executed by the computer 14 and the print control device 16. In this case, when the communication control device 18 receives an image control command transmitted from the image forming device 12, the communication control device 18 selects the computer 14 and the print control device 16 as transmission destinations, and may transmit the image control command to the computer 14 and the print control device 16.

(Sixth Communication Control Example)

An example of communication control performed when checking the matching between the image data generated from the print control device 16 and the output image generated from the image forming device 12 will be described below. The matching is checked by checking an image itself (verification of whether an output image corresponds to image data or not) or checking an output order.

The check of matching can also be performed by comparing and collating the output image and the image data. However, since complex image processing is required, in the present embodiment, a code or a bar code for matching check is printed in the margin of a sheet of paper in the image forming device 12. A scanner or a bar code reader is connected as the external device 40 to the image forming device 12. When the output image and the image data are collated and compared, the scanner may be connected as the external device 40 to the image forming device 12. In place of connecting the bar code reader or the scanner to serve as the external device 40, a sensor for reading a code or a bar code from an output image or an image corresponding to the output image (for example, a toner image formed on a photoreceptor drum or on an intermediate transfer belt) may be arranged in the image forming device 12.

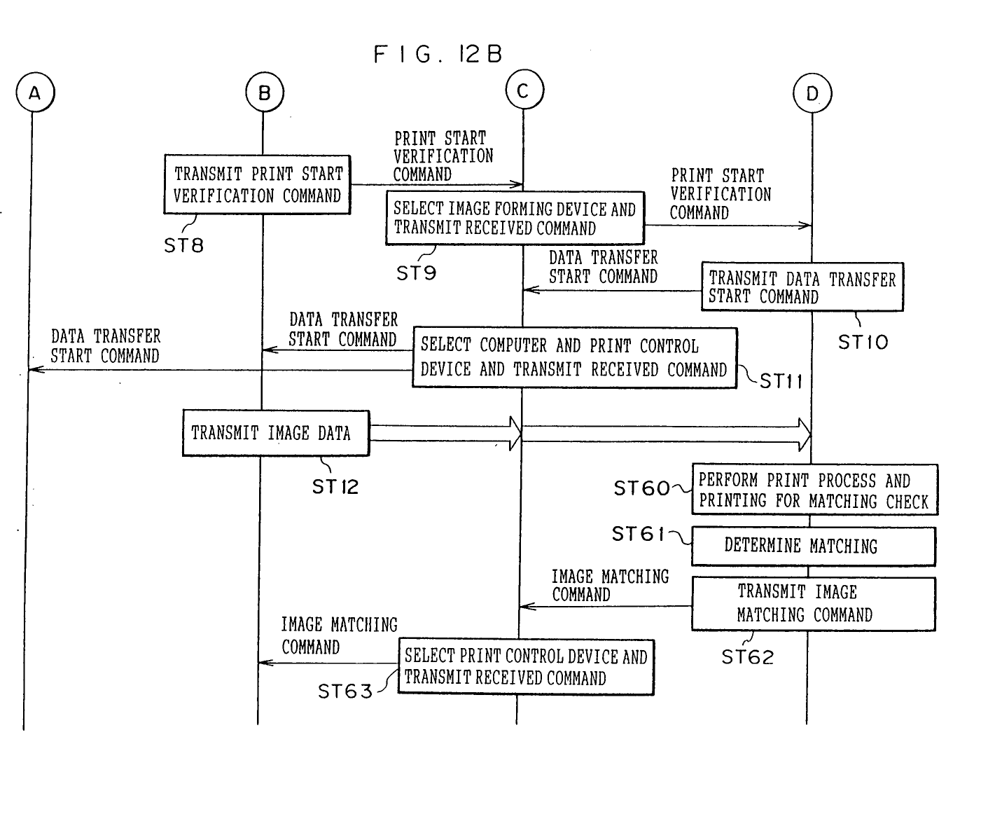

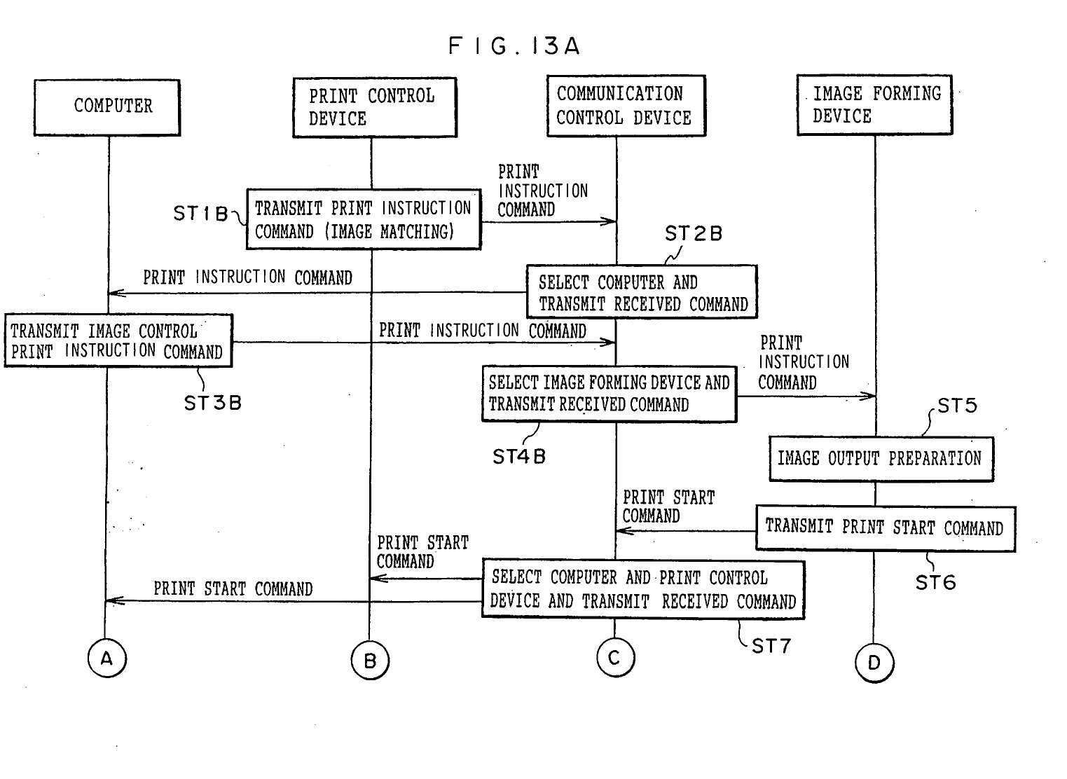

A case in which image data and an output image are matched with each other will be described below with reference to FIGS. 12A and 12B. The processes in FIGS. 12A and 12B that are the same as in FIGS. 6A and 6B are indicated by the same step numbers, and a detailed description thereof will be omitted.

As shown in FIGS. 12A and 12B, in the print control device 16, when matching must be checked, the print control device 16 receives a print job to transmit a print instruction command to which data indicating that matching check is performed is added (step ST1B). The print instruction command is transmitted to the computer 14 by the communication control device 18 as in the first communication control example (step ST2B). When the print instruction command is sent back from the computer 14 (step ST3B), the computer 14 transmits the print instruction command to the image forming device 12 (step ST4B)

Subsequently, as in the first communication control example, an image output preparation process is performed by the image forming device 12. After a print start command, a print start verification command, and a data transfer start command are transmitted and received between the image forming device 12, the computer 14, and the print control device 16 through the communication control device 18 (steps ST5 to ST11), transmission of image data is started in the print control device 16 (step ST12). The image data is transmitted to the image forming device 12 through the communication control device 18.

The image forming device 12 receives the image data and performs a printing process based on the image data, and prints a code or a bar code for matching check in a margin (step ST60). The image forming device 12 causes the scanner or the bar code reader serving as the external device 40 to read the code or the bar code for matching check from the output image obtained by the printing process. Based on the read result, matching between the image data and the output image is determined (step ST61).

When the image data and the output image match with each other, the image forming device 12 transmits an image matching command indicating that the image data and the output image match (step ST62). The image matching command corresponds to a command from the image forming device, which provides notification that the image data of the invention matches with the formed image.

The image matching command is received by the communication control device 18. When the communication control device 18 receives the image matching command, the communication control device 18 selects the print control device 16 as a transmission destination to transmit the image matching command to the print control device 16 (step ST63). In this manner, the communication control device 18 can notify the print control device 16 that the image data and the output image match. Then, the print control device 16 proceeds as usual to the next process (for example, transmission of a print instruction of the next page).

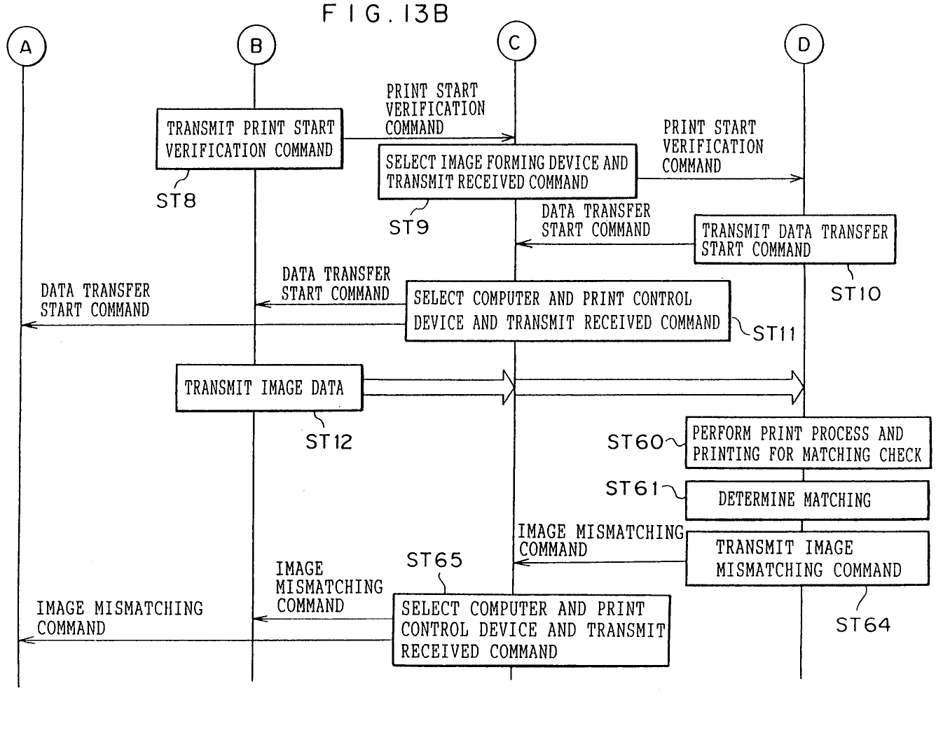

A case in which the image data and the output image do not match will be described below with reference to FIGS. 13A and 13B. The processes in FIGS. 13A and 13B that are the same as in FIGS. 6A and 6B, and FIGS. 12A and 12B are indicated by the same step numbers, and a detailed description thereof will be omitted.

As shown in FIGS. 13A and 13B, when a result obtained by determining the matching (step ST61) indicates that the image data and the output image do not match, the image forming device 12 transmits an image mismatching command indicating that the image data and the output image do not match (step ST64). The image matching command corresponds to a command from the image forming device 12 which provides notification that the image data of the invention does not match with the formed image.

The image mismatching command is received by the communication control device 18. When the communication control device 18 receives the image mismatching command, the communication control device 18 selects the computer 14 and the print control device 16 as transmission destinations to transmit the image mismatching command to the computer 14 and the print control device 16 (step ST65). In this manner, the communication control device 18 can notify the computer 14 and the print control device 16 that mismatching occurs. In the computer 14 and the print control device 16, for example, a predetermined error processing is performed such that a print operation of an active print job is stopped.

The above can be summarized as follows. That is, in the present embodiment, the communication control device 18 which is communicably connected to each of the image forming device 12, the computer 14, and the print control device 16 is arranged, so that the image forming device 12, the computer 14, and the print control device 16 can communicate with each other through the communication control device 18. Therefore, commands transmitted from the image forming device 12, the computer 14, and the print control device 16 are received by the communication control device 18. When the communication control device 18 receives a command transmitted from any one of the image forming device 12, the computer 14, and the print control device 16, based on the relation information 72, a transmission destination is automatically selected from devices other than the device of the transmission source of the received command to transmit the command to the device of the selected transmission destination.

In this manner, the communication control device 18 classifies transmission destinations of commands, so that communication between the image forming device 12, the computer 14, and the print control device 16 can be performed. For example, communication between the image forming device 12 and the print control device 16 can also be performed without passing through the computer 14. Therefore, even when a general-purpose PC in which a non-real-time OS is installed is used as the computer 14, communication time is not lost, and response time can be shortened. Since a load on the computer 14 and communication resources thereof can be reduced, even when a large amount of information or unnecessary information for the computer 14 is transmitted, the computer 14 carries no risk of causing an abnormality to occur, and the image forming system 10 can be stably operated.

When the structure of the image forming system 10 is changed or when a function is added to the image forming system 10, the image forming system 10 can cope with the addition or the change by just modifying the firmware (the program 70 and the relation information 72, or in some cases only the relation information 72). In addition, even when a required response time is changed due to an accelerated speed of the image forming device 12, the image forming system 10 can easily cope with the change in response time by changing the firmware of the communication control device 18. Since the communication control device 18 may have a simple structure as shown in FIG. 3, the communication control device 18 can be realized at low cost.

The present invention can also be applied to a case in which, in addition to the image forming device 12, the computer 14, and the print control device 16, a device that must communicate with these devices is added. In this case, the added device is communicably connected to the communication control device 18, and the firmware of the communication control device 18 may be changed in accordance with the addition.

What is claimed is:

1. An image forming system comprising:
a plurality of devices including at least an image forming device which forms an image based on image data, a control device which controls an operation of the image forming device based on an instruction input through a user interface, and an input device which inputs the image data; and
a communication controller, which can communicate with each of the plurality of devices, and, when the communication controller receives a command transmitted from any one of the plurality of devices, based on the received command, selects at least one device as a transmission destination from the plurality of devices except a transmission source of the received command, and transmits the received command to the selected device.

2. The image forming system of claim 1, wherein the communication controller selects the control device and the input device as transmission destinations when the received command is a command from the image forming device which requests the image data to be transferred in response to the time the image is formed.

3. The image forming system of claim 1, wherein the communication controller:
selects the image forming device as a transmission destination when the received command is a command from the control device which requests a diagnosis of the state of the image forming device, and
selects the control device as a transmission destination when the received command is a command from the image forming device which provides notification of the state of the image forming device as a result of the diagnosis.

4. The image forming system of claim 1, wherein the communication controller selects the image forming device and the input device as transmission destinations when the received command is a command from the control device which either instructs power supply control or provides notification of abnormality in the control device.

5. The image forming system of claim 1, wherein the communication controller selects a device which performs at least some of processes for performing image control to adjust an image formed by the image forming device as a transmission destination when the received command is a command from the image forming device which provides information on the formed image.

6. The image forming system of claim 1, wherein the communication controller selects any one of the control device and the input device as a transmission destination when the received command is a command from the image forming device which provides notification that the image data and the formed image match with each other, and
selects both the control device and the input device as transmission destinations when the received command is a command from the image forming device, which provides notification that the image data and the formed image do not match with each other.

7. The image forming system of claim 1, wherein the communication controller comprises a memory in which relation information between the type of the command and a device serving as a transmission destination is stored, and
selects a device relating to the received command based on the relation information.

8. The image forming system of claim 1, wherein the communication controller is arranged in the image forming device.

9. A communication control device included in the image forming system, the communication control device comprising:
a plurality of communication controllers corresponding to each of a plurality of devices included in the image forming system; and
a controller, which performs control so that when a command is transmitted from any one of the plurality of devices through the communication controller corresponding to the selected devices, at least one device is selected as a transmission destination from the plurality of devices except a transmission source of the received command, and control is performed such that the received command is transmitted to the selected device through the communication controller corresponding to the selected device,
wherein the plurality of devices includes at least an image forming device that forms an image based on image data, a control device that controls an operation of the image forming device based on an instruction input through a user interface, and an input device that inputs the image data.

10. The communication control device of claim 9, further comprising a memory in which relation information between the type of the command and a device serving as a transmission destination is stored,
wherein a device related to the received command is selected based on the relation information.

11. The communication control device of claim 9, wherein the communication control device is arranged in the image forming device.

12. A method of controlling communication among a plurality of devices included in an image forming system, the method being performed by a communication control device included in the image forming system, the method comprising the steps of:
(a) receiving a command transmitted from any one of the plurality of devices;
(b) selecting at least one device from the plurality of devices except a transmission source of the received command as a transmission destination based on the received command; and
(c) transmitting the received command to the selected device;
wherein the plurality of devices include at least an image forming device that forms an image based on image data, a control device that controls an operation of the image forming device based on an instruction input through a user interface, and an input device that inputs the image data.

13. The method of claim 12, wherein, in the step (b), the control device and the input device are selected as transmission destinations when the received command is a command from the image forming device which requests the image data to be transferred in response to the time the image is formed.

14. The method of claim 12, wherein, in the step (b),
the image forming device is selected as a transmission destination when the received command is a command from the control device which requests a diagnosis of the state of the image forming device, and
the control device is selected as a transmission destination when the received command is a command from the image forming device which provides notification of the state of the image forming device as a result of the state diagnosis.

15. The method of claim 12, wherein, in the step (b), the image forming device and the input device are selected as transmission destinations when the received command is a command from the control device which instructs power supply control or provides notification of an abnormality in the control device.

16. The method of claim 12, wherein, in the step (b), a device which performs at least some of processes for performing image control to adjust an image formed by the image forming device is selected as a transmission destination when the received command is a command from the image forming device which provides information on the formed image.

17. The method of claim 12, wherein, in the step (b), any one of the control device and the input device is selected as a transmission destination when the received command is a command from the image forming device which provides notification that the image data and the image match with each other, and
both the control device and the input device are selected as transmission destinations when the received command is a command from the image forming device, which provides notification that the image data and the formed image do not match with each other.
